(19) United States
(12) Patent Application Publication
(10) Pub. No.: US 2013/0339871 A1
(43) Pub. Date: Dec. 19, 2013

(54) Software Application Abstraction System and Method

(71) Applicant: Purna C. Ramini, Bentonville, AR (US)

(72) Inventor: Purna C. Ramini, Bentonville, AR (US)

(73) Assignee: WAL-MART STORES, INC., Bentonville, AR (US)

(21) Appl. No.: 13/524,043

(22) Filed: Jun. 15, 2012

(51) Int. Cl. G06F 3/01; G06F 15/16

(52) U.S. Cl. 715/746

(57) ABSTRACT

Exemplary embodiments are directed to a client-server environment for abstracting a software application to be executed by a client device. A request for execution of a remote software application includes a client parameter associated with the client device and an application parameter associated with the requested software application is identified. At least one rule is applied to the software application to determine a manner in which the software application operates for the client device based on the client parameter and the application parameter.

### BACKGROUND

Conventionally, devices can have configurations and/or operational characteristics (e.g., device type, software platform, etc.) that dictate which software applications can be run by the devices such that software applications generally either work (i.e. are compatible) or do not work (i.e. are incompatible) on a given device based on a configuration and/or operational characteristics associated with the device. For example, incompatibility issues can exist when a client device configuration and/or operational characteristic does not satisfy platform and/or version requirements of the software application. To accommodate different devices having different configurations and/or characteristics and the incompatibility issues resulting therefrom, software developers conventionally create a version of a software program for each of the configurations and/or operational characteristics of the devices on which the software application is to be run. A device having a particular configuration and/or operational characteristics can generally run an instance of the software application created for the configuration and/or characteristics associated with the device and conventionally cannot run an instance of the software application created for a different configuration and/or characteristics associated with another device.

Some examples of client device configurations and/or operational characteristics include a type and/or speed of a client device's processor, a size of memory in the client device, an operating system implemented by the client device, a web browser implemented by the client device, a type of client device (e.g., PC, MAC, laptop, tablet, phone), and the like. A software application can require that a client device have or implement some or all of these configuration and/or operational characteristics to be compatible with the software application. As one example, a client device can be configured to implement a software platform including an operating system (e.g., Windows® from Microsoft) and a software application can be coded to run on a different operating system (e.g., OS X from Apple) such that the software application is incompatible with the operating system implemented by the client device. Some examples of operating system that can be implemented by a client device include Windows® and Windows® Phone from Microsoft, Android from Google, OS X and iOS from Apple, and Linix.

In some instances, software applications can be implemented as web applications. A web application is a software application that resides on a server and is accessed by a client device via a communications network. Conventionally, the client device includes a client-side application that is programmed and/or configured to execute or interact with the web application. For example, a common type of client-side application is a web browser installed on the client device. Some examples of web browsers include Internet Explorer from Microsoft, FireFox from Mozilla, Chrome from Google, Safari from Apple, and so on. Web applications that are executable by, or can interact with web browsers can be coded in a browser-supported language, such as HTML, JavaScript, and/or other browser supported languages and can support one or more transmission protocols (e.g., TCP/IP, HTTP, Socket, etc.). Conventionally, a web application requires a compatible client-side application for execution by the client device. For example, if a web browser is incompatible with the web application, e.g., if the language in which the web application is coded is not supported by a web browser, the web application cannot be executed using the web browser (i.e. the web application is incompatible with the client device).

For enterprises that use devices having different configuration and/or operational characteristics, a lack of software compatibility between the devices can be burdensome and create infrastructure issues for the enterprises. For example, in order for an enterprise that uses devices having different configurations and/or characteristics to make a software application available for each of the devices, the enterprise must develop, acquire, install, and/or maintain a separate and compatible version of the software application for each configurations and/or characteristics associated with the devices.

### SUMMARY

Exemplary embodiments of the present disclosure are related to a client-server environment in which a software application that resides on the server is abstracted by an application abstraction system to facilitate execution of the software application by a client device. Abstraction of a software application hides at least a portion of the implementation details from the device executing the software application by providing an execution interface that programmatically compensates for incompatibility issues due to the coding of the software application for a specific configuration and/or operational characteristic (e.g., device type and platform) of a client device.

Exemplary embodiments of the application abstraction system can abstract a software application based on client parameters associated with the client device, application parameters associated with the software application to be abstracted, and/or one or more rules implemented by embodiments of the application abstraction system so that the software application can be executed by the client device, which would conventionally be incompatible with and would not be able to execute the software application. Exemplary embodiments alleviate the burden and infrastructure issues faced by enterprises by providing a system to accommodate client devices having different configurations and/or characteristics without having to develop, acquire, install, and/or maintain different versions of a software application for each configuration and/or characteristic of the client devices.

In one embodiment, a method of transforming an incompatible software application to a compatible software application for a client device in a client-server environment is disclosed. The method includes receiving a request from a client device for an incompatible software application stored by a server. The request is associated with at least one client parameter associated with the client device that identifies an operational characteristic of the client device. The method also includes programmatically identifying an application parameter associated with the incompatible software application and programmatically modifying a graphical user interface of the incompatible application for display on the client device based on the client parameter and the application parameter.

In another embodiment, a non-transitory computer readable medium storing instructions is disclosed, wherein execution of the instructions by a configurable processing device causes the processing device to receive a request from a client device for an incompatible software application stored by a server. The request is associated with at least one client parameter associated with the client device that identifies an operational characteristic of the client device. Execution of the instructions also causes the processing device to programmatically identifying an application parameter associated with the incompatible software application and programmatically modifying a graphical user interface of the incompatible application for display on the client device based on the client parameter and the application parameter.

In yet another embodiment, a system for transforming an incompatible software application to a compatible software application in a client-server environment is disclosed one or more servers programmed to receive a request from a client device over a communications network for an incompatible software application stored by the one or more servers. The request is associated with at least one client parameter associated with the client device identifying an operational characteristic of the client device. The one or more servers are also programmed to identify an application parameter associated with the incompatible software application and modify a graphical user interface of the incompatible application for display on the client device based on the client parameter and the application parameter.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is block diagram of an exemplary embodiment of an environment programmed and/or configured to abstract applications.

FIG. 2 is an exemplary client-server environment in which an exemplary embodiment of the environment of FIG. 1 is implemented.

FIG. 3 is another exemplary client-server environment in which an exemplary embodiment of the environment of FIG. 1 is implemented.

FIG. 4 illustrate an exemplary data flow between client devices and an embodiment of the environment programmed and/or configured to abstract applications.

FIG. 5 is a flowchart of an operation of an exemplary embodiment of the environment of FIG. 1.

FIG. 6 is an exemplary graphical user interface of a software application for display by a client device.

FIG. 7A is a graphical user interfaces that can be created in accordance of the present disclosure to replace a portion of the graphical user interface of FIG. 5.

FIG. 7B is another graphical user interfaces that can be created in accordance of the present disclosure to replace a portion of the graphical user interface of FIG. 5.

FIG. 7C is another graphical user interfaces that can be created in accordance of the present disclosure to replace a portion of the graphical user interface of FIG. 5.

FIG. 8 is an exemplary computing device programmed and/or configured to implement one or more aspects of an exemplary embodiment of the environment of FIG. 1.

### DESCRIPTION OF EXEMPLARY EMBODIMENTS

Exemplary embodiments of the present disclosure are related to a client-server environment in which a software application that resides on the server is abstracted by an application abstraction environment to facilitate execution of the software application by a client device and/or to control an appearance of the software application on the client device. Exemplary embodiments of the application abstraction environment can abstract a software application based on client parameters associated with the client device, application parameters associated with the software application to be abstracted, and/or one or more rules implemented by embodiments of the application abstraction environment. Exemplary embodiments of the environment can programmatically modify graphical user interfaces of the software application to generate client device-specific graphical user interfaces based on the client parameters and/or the application parameters.

Exemplary embodiments of the application abstraction environment can be programmed and/or configured to abstract a software application developed for a client-side application in a client-server environment so that the software application can be executed by another client-side application in the client-server environment that would conventionally be incompatible with and would not be able to execute the software application.

Exemplary embodiments of the environment advantageously alleviate the burden and infrastructure issues faced by enterprises by providing an environment to accommodate client devices having different configurations and/or characteristics (e.g., different client-side applications and environments) without having to develop, acquire, install, and/or maintain different versions of a software application for each configuration and/or characteristic of the client devices. Therefore, a client device having a particular configuration and/or characteristic can execute an abstraction of a software application that would otherwise be incompatible with the client device.

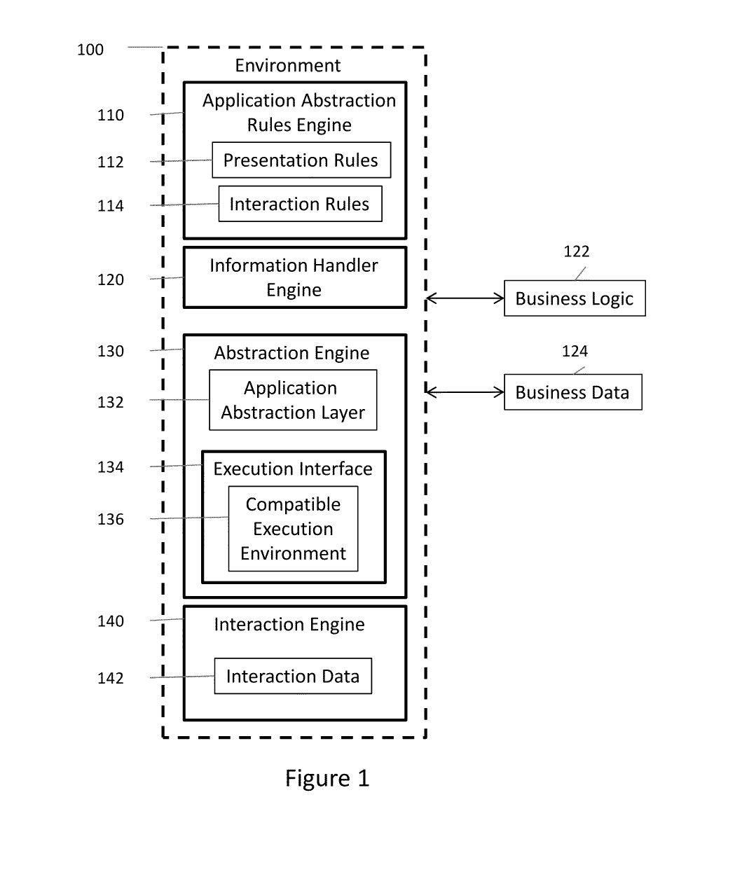

FIG. 1 is a block diagram of an exemplary server-side application abstraction environment 100. The environment 100 can include a rules engine 110, an information handler engine 120, an abstraction engine 130, and an interaction engine 140. The components (e.g., engines 110, 120, 130, 140) of the environment 100 can be programmed and/or configured to abstract one or more software applications based on client parameters associated with a client device requesting the software application, application parameters associated with the requested software applications, and/or one or more rules defined by the environment 100 and/or a user (e.g., a system administrator).

Client parameters can describe a device configuration and/or one or more operational characteristics of the client device and/or a client-side application implemented by the client device that is requesting the implementation of the software application. Some examples of client parameters include, but are not limited to a type of device (e.g., a personal computer, laptop, tablet, phone), a processor of the device (e.g., a type and speed of the processor), an operating system (or version thereof) implemented by the device (e.g., Windows, OS X, iOS, Android), a web browser (or version thereof) implemented by the device (e.g., Internet Explorer, Safari, Chrome, FireFox), a display size of the device, a display resolution of the device, a network communication protocol implemented by the device (e.g., TCP, UDP, Internet socket), and any other parameters associated with an operation, configuration, and/or behavior of the client device.

Application parameters can describe attributes and/or characteristics associated with the software application including, for example, attributes and/or characteristics corresponding to an operation and/or appearance of the application on the client device. Some examples of application parameters include, but are not limited to a programming language, a minimum device configuration and/or operating requirement (e.g., processor speed, network connection speed, memory, operating system, display size, display resolution, and/or web browser with which the software application is coded to operate), a network communication protocol implemented by the software application (e.g., TCP, UDP, Internet socket), and any other parameters associated with an implementation, execution, appearance, and/or operational requirement of the software application.

The rules engine 110 can be programmed and/or configured to manage presentation rules 112 and/or interaction rules 114 that are relevant to a context in which a software application is to be abstracted. For example, the rules engine 110 can be programmed and/or configured to manage an implementation of the presentation rules 112 and/or interaction rules 114 based on client parameters and application parameters associated with the execution of the software application by a given client device.

The presentation rules 112 are applied to a software application by the rules engine 110 to dictate the manner in which graphics associated with the software application are rendered on a display of a client device. An application of the presentation rules 112 can be determined based on client parameters and application parameters such that the appearance of graphics associated with the software application are rendered differently on different devices having different device configurations and/or operational characteristics. The presentation rules can be programmatically used by the rules engine 110 to manage and/or control a look and feel of the software application executed by the client device. For example, the presentation rules 112 can be programmatically used by the rules engine 110 to manage and control an appearance of a graphical user interface (GUI) of the software application being displayed on a display of the client device to remove, add, or modify graphics, data entry fields, buttons, and/or other information displayed by the software application.

The interaction rules 114 can include, for example, rules to determine the manner in which a client device interacts with a software application to control an operation of the software application with respect to the client device. The interaction rules 114 can be programmatically used by the rules engine 110 to manage and/or control a transmission and/or reception of data between the client device and the software application including a format, transport protocol, data flow between the client device and the software application, and/or other interactions between the client device and the software application. The interaction rules 114 can be programmatically used by the rules engine 114 to control and/or manage an availability of operations and/or functions of the software application. For example, the interaction rules 114 can be programmatically used by the rules engine 110 to manage and/or control which of the operations and/or functions of the software application make available to the client device and/or which of the operations and/or functions of the software application to make unavailable to the client device.

The information handler engine 120 can be programmed and/or configured to handle requests or queries for information from business logic 122 and/or business data 124 associated with the enterprise and to interface with the business logic 122 and/or the business data 124 to retrieve the information in response to the requests or queries. The business logic 122 and/or business data can be stored in one or more databases that can be accessed by the information handler engine 120. The information handler engine 120 can form an interface through which the enterprise business logic 122 and/or business data 124 communicate with a client device executing an abstracted software application to facilitate processing queries from the software application executed by the client device and processing responses from the business logic 122 and/or business data 124. The information handler engine 120 can be programmed include a mapping of queries from the software application to queries executable by the database(s) in which the business logic and/or business data is stored and can be programmed to support transport and/or communication protocols and their extensions. A client device implementing an abstracted software application can programmatically interact with the information handler engine 120 to access, retrieve, view, modify, update, implement, and/or otherwise interact with the business logic 122 and/or business data 124.

For example, the information handler engine 120 can be programmed with a set of software application requests or queries that can be received from the software application and can be programmed with a set of business logic and business data requests or queries that can be processed by the database(s) in which the business logic 122 and/or business data 124 is stored. The information handler engine 120 can include a mapping between the software application set of requests or queries and the business logic and/or business data set of requests or queries such that when the information handler engine 120 receives a request or query from a software application for information from the business logic 122 and/or business data 124, the information handler engine 120 can transform or convert the received request or query into a request or query that can be processed by the database(s) on which the business logic 122 and/or business data 124 is stored. Likewise, when the information handler engine 120 receives a response to a request or query for information from the business logic 122 and/or business data 124, the information handler engine 120 can programmatically format the information in a format that can be processed by the application and can subsequently transmit the information to the client device executing the software application in the format.

The business logic 122 can provide software modules and/or algorithms coded to manage and/or control an exchange of information (e.g., business data 124) with a client device. For example, the business logic 122 can include software modules and/or algorithms coded to access, retrieve, modify, and/or create business data 124.

The business data 124 can include information corresponding to activities, operation, management, and/or programs carried out by an enterprise. For example, business data can include sales, revenue, inventory, research and development, projects, and/or any other suitable information corresponding to the enterprise.

The abstraction engine 130 can be programmed and/or configured to abstract a software application based on the client parameters, the application parameters, the presentation rules 112, and/or the interaction rules 114 and to provide an application abstraction layer 132. In some embodiments, the abstraction engine 130 can be programmed and/or configured to superimpose the client capabilities (e.g., defined by the client parameters) and application capabilities (e.g., defined by the application parameters) using the presentation rules 122 and/or interaction rules 124 to provide an executable unit of the software application for execution by the client-side application implemented by the client device.

The abstraction engine 130 can programmatically control the manner in which the software application is presented or rendered on the client device using, for example, the presentation rules 112, the client parameters, and/or the application parameters. As one example, the client device executing the software application may not be able to correctly and/or adequately display one or more graphical user interfaces (GUIs) of the software application because, for example, the size of the display of the client device is too small and/or the resolution of the display is too low. The abstraction engine 130 can programmatically modify the one or more GUIs in response to the client parameters (e.g., display size and/or resolution), application parameters (e.g., structure and appearance of the GUIs), and the presentation rules so that the content of the one or more GUIs can be correctly and/or adequately displayed.

The abstraction engine 130 can programmatically control the manner in which the client device interacts with the software application using, for example, the interaction rules, the client device parameters, and/or the application parameters. As one example, a software application may use location information of a client device during an execution of the software application to, for example, determine which options or information to display to a user. If the client device does not or cannot provide this location information, the abstraction engine 130 can modify an interaction between the client device and the software application such the location feature of the software application is disabled or modified based on the interaction rules (e.g., when location is not available either disable or modify the location feature of an application). To modify the software application, the abstraction engine 130 can modify a GUI of the software application so that the location can be entered by the user. The modification of the GUI can be performed in accordance with the presentation rules (e.g., when location information is requested by the software application and the interaction rules specify that the software application be modified to allow a user to enter the location information, modify the GUI to allow the user to enter the location information). Location information can include a geographic location of the client device including a country, state, town, city, and/or county in which the client device located. Client device location information can include a building that the client device is in, a floor the client device is on in a building, and/or any other suitable location information. In exemplary embodiments, the location information can be specified based on an Internet Protocol (IP) address, a Machine Access Control (MAC) address, a global positioning signal from a global positioning system, mobile positioning, and the like.

The abstraction engine 130 can be programmed and/or configured to abstract the software application to hide the implementation details of the software application using the application abstraction layer 132 to programmatically provide an execution interface 134 between the software application and the client device through which the client device can interact with the software application. The execution interface 134 can generate a compatible execution environment 136 based on the client parameters, the application parameters, the presentation rules 112, and/or the interaction rules 114 to facilitate execution of an incompatible software application by a client device. The compatible execution environment 136 of the execution interface 134 can be programmed to transform, adapt, convert, and/or otherwise handle an interaction between the incompatible software application and the client device so that the client device can execute and/or interact with the incompatible software application through the compatible execution environment 136 generated by the execution interface 134.

For example, the compatible execution environment of the execution interface 134 can be configured and/or programmed to receive data and/or commands from the client device and transform, adapt, or convert the data and/or commands to a format that the software application can process and can pass the converted data and/or commands to the software application for processing by the software application. The compatible execution environment 136 of the execution interface 134 can also receive data and/or commands from the software application and can transform, adapt, or convert the data and/or commands to a format that the client device can process and can pass the transformed, adapted, or converted data and/or the commands to the client device for processing by the client device. In an exemplary embodiment, the abstraction engine 130 can be programmed and/or configured to provide the compatible execution environment 136 of the execution interface 134 between a client device and a software application by encapsulating the software application to hide the implementation details of the software application.

The interaction engine 140 can be programmed and/or configured to receive, store, and/or maintain interaction data 142. The interaction data 142 can define a state of the software application instances being executed by one or more client devices at one or more instances of time. In exemplary embodiments, the interaction data 142 can include client parameters, application parameters, and/or any other information from which a state of a software application being executed by a client device can be determined. The interaction engine 140 can be programmed and/or configured to interface with the rules engine 110, information handler engine 120, and/or abstraction engine 130 to programmatically provide the interaction data 140 to the rules engine 110, information handler engine 120, and/or abstraction engine 130. The interaction engine 140 can be programmed and/or configured to restore a state of the software application on a client device using the interaction data 142 in the event that, for example, execution of the software application ceases, communication is lost between the client and the environment 100, and/or for any other event for which the state of the software application is to be restored.

In exemplary embodiments, the interaction engine 140 can be programmed and/or configured to facilitate transfer of a software application being executed by a client device to another client device while maintaining a state of the application. For example, the interaction engine 140 can receive a request from a client device executing a software application to transfer the software application to another client device. In response to the request, the interaction engine 140 can transmit the interaction data 142 corresponding to the execution of the software application by the client device to the other client device and the other client device can begin executing the software application where the previous client device ceases execution.

In an exemplary operation, a software application can be implemented as a web application to be executed by a client-side application resident on a client device. The client device can request the web application from the environment 100 via a communications network. One or more client parameters can be included in the request (e.g., an identity of the client-side application, a transport protocol used by the client-side application, etc.), which can be used by the environment 100 to programmatically determine whether the requested web application is compatible with the client-side application. The environment 100 can be programmed and/or configured to implement an application abstraction process in response to a determination that the requested web application is not compatible with the client-side application. The application abstraction process can implement the application abstraction layer 132 to provide an execution interface 134 between the web application and the client-side application so that the client-side application can execute an abstracted instance of the web application.

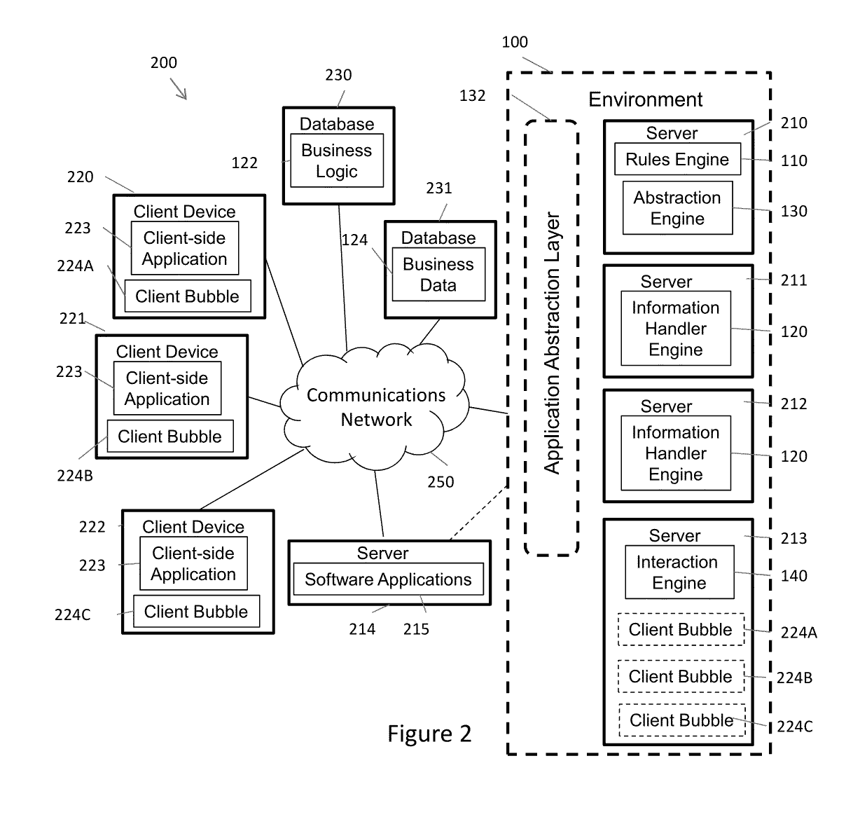

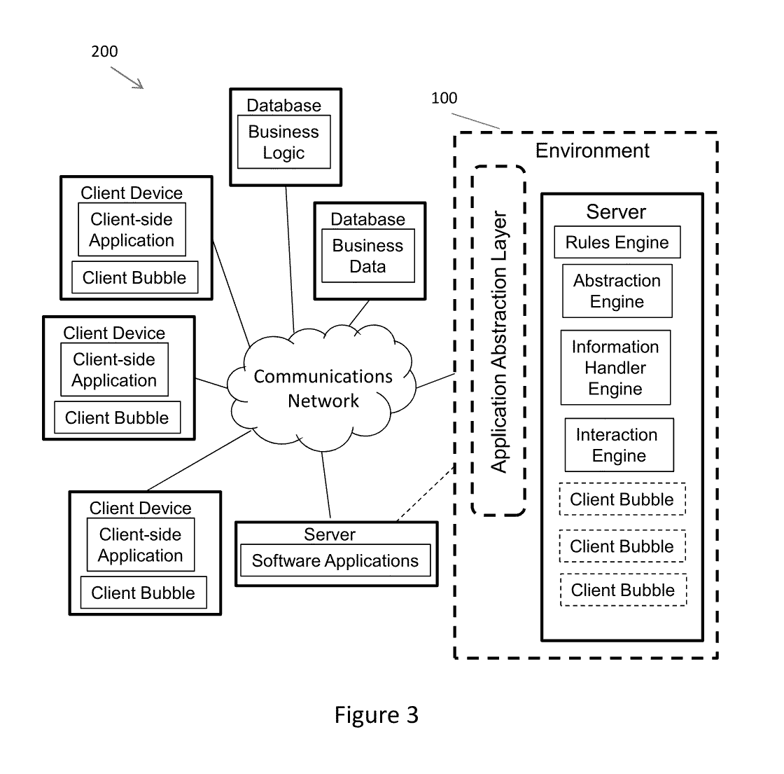

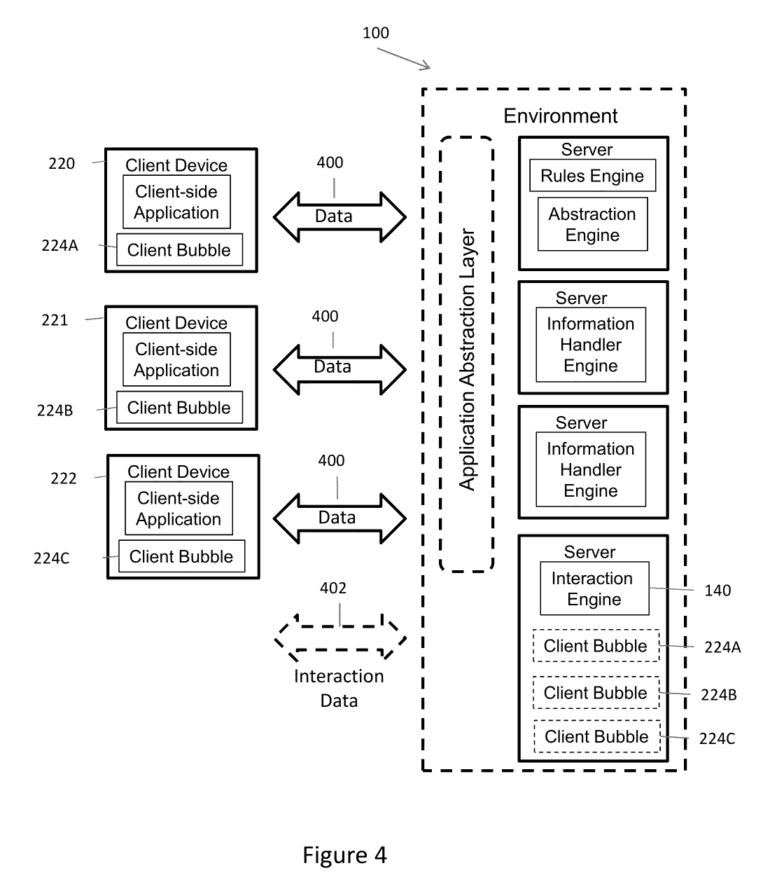

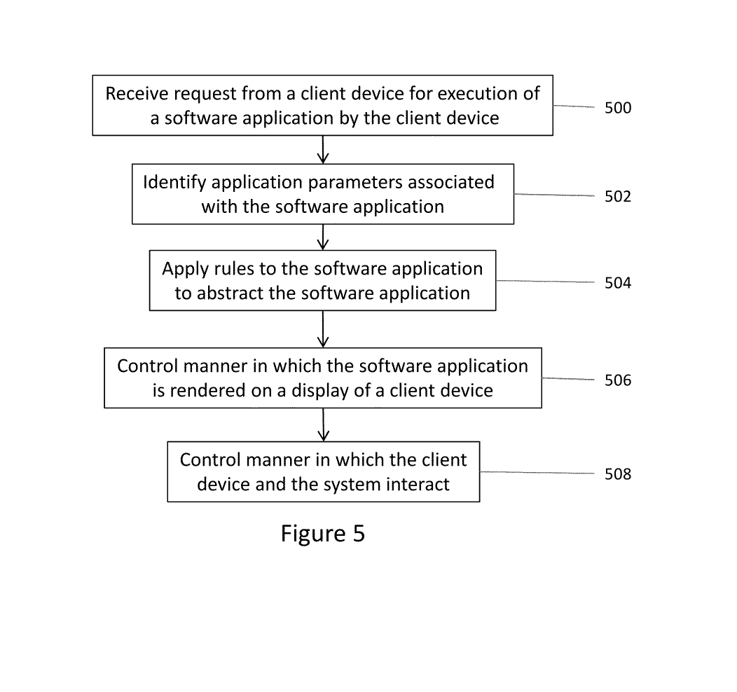

FIG. 2 is a block diagram of an exemplary client-server environment 200 configured to implement one or more embodiments of the environment 100. The computing environment 200 includes servers 210-214 programmed and/or configured to be communicatively coupled to client devices 220-222, via a communication network 250. In this embodiment, the server 210 can be programmed and/or configured to implement the rules engine 110 and the abstraction engine 130, the servers 211, 212 can be programmed and/or configured to implement the information handler engine 120, the server 213 can be programmed and/or configured to implement the interaction engine 140, and the server 214 can be programmed and/or configured to include software applications 215 for execution by the client devices 220. Databases 230-231 can store the business logic 122 and business data 124, respectively. The servers 210-214, client devices 220-222, and databases 230-231 can be implemented as computing devices. An exemplary computing device is shown in FIG. 4. While the engines 110, 120, 130, and 140 are distributed across different servers 210-213, those skilled in the art will recognize that the engines 110, 120, 130, and 140 can each be implemented by a single server (FIG. 3), different servers, or in different combinations by one or more servers. Furthermore, while three client devices 220-222 and five servers 210-214 are shown in this embodiment, those skilled in the art will recognize that more or fewer client devices and/or servers can be implemented in accordance with exemplary embodiments if the present disclosure.

The client devices 220-222 can each include a client-side application 223 for executing one or more software applications 215 residing on the server 214. In exemplary embodiments, the client-side application 223 can be a web browser, a mobile phone application, a client-side enterprise application, and/or any other application programmed and/or configured to execute or interact with one or more software applications resident on one or more servers. The client-side application 223 can be compatible with some, all, or none of the software applications 215 such that, in some instances, the client-side application 223 is not programmed and/or configured to execute one or more of the software applications.

Each of the client devices 220-222 can be programmed and/or configured to store a client bubble 224A-C, respectively. The client bubbles 224A-C are sets of data that include one or more parameters associated with a client device and/or associated with a software application being executed by the client device (e.g., client device parameters and/or application parameters). In exemplary embodiments, the client bubbles 224A-C can be data structures. For example, the client bubbles 224A-C can be defined as classes with methods and data and can be instantiated as an object that can be passed from the client devices 220-222 to one or more of the servers 210-213. The client bubble 224 is client-capability aware and application-capability aware such that the client bubble 224 includes the data used by the environment 100 to programmatically abstract a version of a software application for implementation by the client device. The client devices 220-222 can manage their states using the client bubbles 224A-C, respectively, so that the application management occurs at the client device to free resources of the servers 210-213 for other tasks. The client bubbles 224A-C can capture a state of execution of the software application at a moment in time based on the client and/or application parameters included in the client bubbles 224A-C.

In exemplary embodiments, the client bubbles 224A-C can be created by the client devices 220-222, respectively, when the client devices 220-222 request an implementation of a software application from the environment 100 and can be deleted when execution of the software application by the client device ceases such that in exemplary embodiments, the client bubble 224 has no persistence in computer storage beyond the execution of the software application. The application parameters can be programmatically inserted into the client bubble 224 by the environment 100 upon request for execution of the application and/or throughout execution of the software application. The client bubble 224 can expand or contract based on the parameters (e.g., client parameters and/or application parameters) that drive an implementation of the software application and can be considered to be a chain of application molecules (minute modules) formed by a combination of the client parameters, the application parameters, and/or the rules implemented by the environment 100 for controlling a presentation and/or interaction between the client device and the software application. In exemplary embodiments, the client bubble 224 can include transport protocol data, presentation rules 112, interaction rules 114, and/or any other parameters corresponding to the client device and/or the software application being executed by the client device. For example, in some embodiments, the client bubble can include information corresponding to a type of device (e.g., a personal computer, laptop, tablet, phone), a processor of the device (e.g., a type and speed of the processor), an operating system (or version thereof) implemented by the device (e.g., Windows, OS X, iOS, Android), a web browser (or version thereof) implemented by the device (e.g., Internet Explorer, Safari, Chrome, FireFox), a network communication protocol(s) implemented by the device and/or software application (e.g., TCP, UDP, Internet socket), a programming language in which the software application is coded, a minimum device configuration and/or operating requirement (e.g., processor speed, network connection speed, memory, operating system, and/or web browser with which the software application is coded to operate), and the like.

The communications network 250 can be any network over which information can be transmitted between devices communicatively coupled to the network. For example, the communication network 250 can be the Internet, an intranet, a virtual private network (VPN), a wide area network (WAN), a local area network (LAN), and the like. The communications network can support one or more transport protocols. For example, the communications network can support the transmission control protocol (TCP), the Datagram Congestion Control Protocol (DCCP), the Stream Control Transmission Protocol (SCTP), sockets, and/or any other suitable transport protocol or suite of protocols to facilitate communication between the environment 100 can the client devices 220-222.

In an exemplary operation, the client device 220 can transmit an application request to the environment 100 via the communications network 250. A client bubble 224 associated with the client device 220 can be generated and data within the client bubble (e.g., client parameters) can be included in the application request or transmitted separate therefrom. The application request can be received by the environment 100 via the application abstraction layer 132, which can be defined by the abstraction engine 130, to begin an application abstraction process. The abstraction engine 130 identifies a software application requested by the client device 220 and determines whether the configuration and/or characteristics of the client device 220, e.g., client parameters, are compatible with the application, e.g., whether the application can be executed by the client device without being abstracted. For example, the abstraction engine 130 can be programmed and/or configured to compare the client parameters included in the request with the application parameters associated with the software application requested. If the client device and the software application are compatible, the application abstraction layer 132 serves as a pass through between the software application and the client device 220.

If the abstraction engine 130 determines that the client device 220 and the software application are incompatible, e.g., the software application cannot be executed by the client device, based on a comparison of the client parameters and the application parameters, the abstraction engine 130 can interface with the rules engine 110 to abstract the software application to facilitate an implementation of the software application by the client device. For example, the rules engine 110 can apply rules, e.g., presentation rules and/or interaction rules, to the software application based on the client and/or application parameters. The abstraction engine 130 can programmatically control the manner in which the software application is rendered on a display of the client device using, for example, the presentation rules, and/or can programmatically control the manner in which the client device interacts with the software application using, for example, the interaction rules, the client device parameters, and/or the application parameters.

The abstraction engine 130 can provide the application abstraction layer 132 to provide an execution interface 134 between the software application and the client device such that data and/or commands received by the environment 100 pass through and are modified by the interface and data and/or commands from the software application pass through and are modified by the interface to facilitate interaction between the client device and the software application. In some embodiments, data transmitted to and from the environment 100 can be formatted in as a web-based document, such as an extensible markup language (XML) document, a JavaScript Object notation (JSON) object, and/or any other suitable format to facilitate communication between the environment 100 and the client device.

The client device can also communicate with the interaction engine 140 to transmit a copy of the client bubble 224 to the interaction engine 140. The transmission of the client bubble 224 to the interaction engine 140 can be performed upon a change in a state of the execution of the software application by the client device. The interaction engine 140 can store or cache the client bubble 224 to capture the state of the software application being executed by the client device at one or more moments in time. In the event that the client device ceases to execute the software application and the client bubble is deleted from the client device, the interaction engine 140 can be programmed and/or configured to restore the client bubble to the client device. In some embodiments, the interaction engine 140 can be programmed and/or configured to facilitate a transfer of a client bubble from one client device to another client device so that the software application being executed by the client device can be transferred to the other client device.

FIG. 4 illustrates an exemplary data flow between the environment 100 and client device 220-222 of FIG. 2. The clients 220-222 can be in bidirectional communication with the environment 100, as shown by arrows 400 to pass data and/or information between the clients 220-222 and the environment 100 to execute software applications via the environment 100. For example, in one embodiment, the client devices 220-222 can communicate using the JSON data interchange. During execution of the software applications by the clients 220-222, the clients can transmit client bubbles 224A-C, respectively, to the interaction engine 140 as shown by arrow 402. The transmission of the client bubbles can occur separately from the data communication shown on arrows 400 such that the transmission of the client bubbles 220-22 does not interfere with the execution of the software applications. The client devices 220-222 can transmit client bubble to the interaction engine 140 to provide the interaction engine 140 with an up-to-date status of the state of execution of the software applications by the client devices. If the client bubbles 224A-C cease to exist on the client device 220-222, respectively, the client devices 220-222 can retrieve a copy of the last client bubble 224A-C transmitted to the interaction engine 140 to resume execution of the software applications at the last stored (e.g., by the interaction engine 140) state of the execution of the software applications. Likewise, if the user of one of the client devices (e.g., client device 220) requests a transfer of the execution of a software application to another client device (e.g., client device 221), the interaction engine 140 can transmit the corresponding client bubble (e.g., client bubble 224A) to the other client device (e.g., client device 221) so that execution of the software application proceed from the last stored (e.g., by the interaction engine 140) state of the software application.

FIG. 4 is an exemplary flowchart for implementing an exemplary application abstraction process in accordance with the present disclosure. The environment 100 can be programmed and/or configured to receive a request from a client device for an application to be implemented by the client device (step 500). In exemplary embodiments, the client device can include a client-side application for executing the software application and the software application can be a web application. The request can include one or more client parameters associated with a configuration and/or characteristics of the client device and/or the client-side application. In some embodiments, the one or more parameters can be used to determine and/or describe a capability of the client device and/or the client-side application and can be maintained in a client bubble by the client device.

In response to the request, the environment 100 can be programmed and/or configured to identify one or more application parameters associated with the software application requested by client device (step 502). For example, the request received by the environment 100 can include an identifier that uniquely identifies the software application and the environment 100 can programmatically compare the identifier to stored identifiers to identify the requested application. Once the software application has been identified, the environment 100 can programmatically obtain the application parameters.

The environment 100 can be programmed and/or configured to apply one or more rules (e.g., presentation rules 112 and/or interaction rules 114) to the application requested by the client device to abstract the software application so that the software application is compatible with the requesting client device (e.g., so that the software application can be executed by the client-side application) based on the client parameters and the application parameters (step 504). In exemplary embodiments, the environment 100 can programmatically abstract the software application by encapsulating the software application to provide an application abstraction layer to operate as an interface between the client device and the software application. The application abstraction layer defined by the abstraction engine 130 can hide the implementation details of the software application.

Using the presentation rules 112, the environment 100 programmatically manages and/or controls the manner in which the software application is rendered on a display of a client device (step 506). For example, the environment 100 can be programmed and/or configured to manage and/or control an appearance of a GUI of the abstracted software application on a display of the client device such that a look and feel of the application is programmatically determined by the environment 100. Likewise, using the interaction rules 114, the environment 100 programmatically manages and/or controls the manner in which the client device and the environment 100 interact (step 508). For example, the environment 100 can be programmed and/or configured to manage and/or control a format, transport protocol, data flow between the client device and the software application, and/or other interactions between the client device and the environment 100.

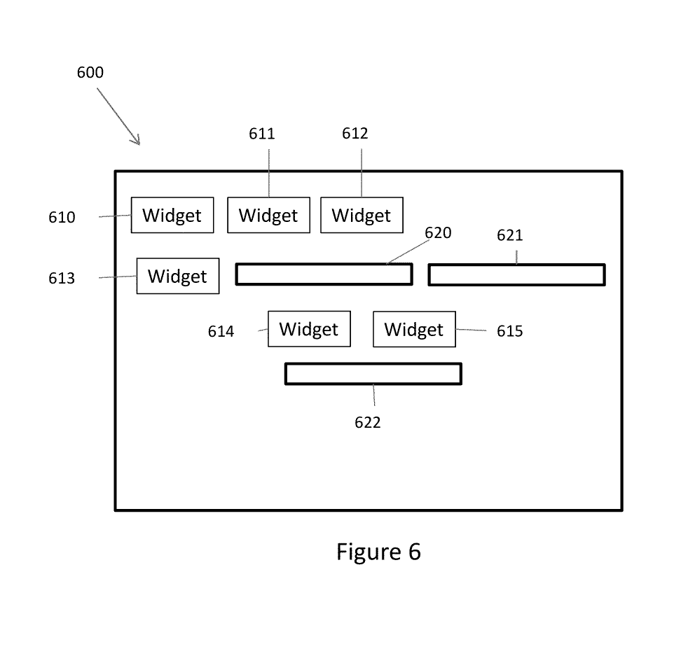

FIG. 6 depicts an exemplary GUI 600 of a software application to be displayed by a client device. The GUI 600 can include widgets 610-615 (e.g., button) and data entry fields 620-622 with which a user can interact through the client device. In exemplary embodiments, due to a size of the client device's display, the client device may not be able to adequately accommodate the widgets 610-615 and data entry fields 620-622 of the GUI 600 on the display at the same time.

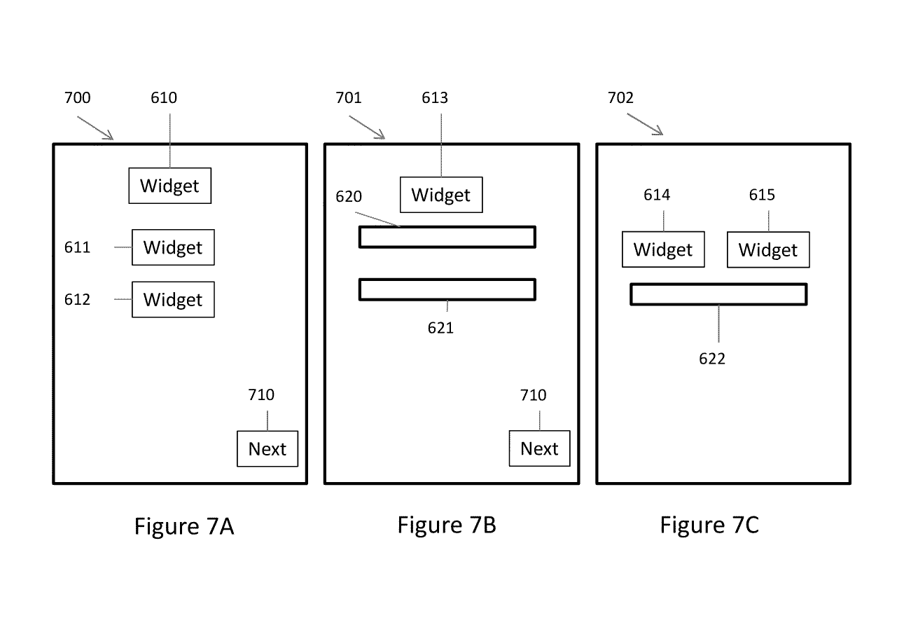

FIGS. 7A-C depict a series of client device specific GUIs 700-702 that can be programmatically created by the abstraction engine 130 to replace the GUI 600 based on the client parameters (e.g., display size), application parameters (e.g., the GUI structure and appearance), and the presentation rules (e.g., a rule that creates several GUIs from a single GUI when the display of the client device cannot accommodate the GUI). Each of the GUIs 700-703 can be created with respect to the size of the display on the client device so that each of the widgets and data entry fields in each of the respective GUIs can be displayed by the client device's display at the same time. For example, the GUI 700 can include the widgets 610-612, the GUI 701 can include the widget 613 and the data entry fields 620-621, the GUI 702 can include the widgets 614-615 and the data entry field 622. When the display of the client device displays the GUI 700, the widgets 610-612 can be displayed on the display at the same time. When the display of the client device displays the GUI 701, the widget 613 and data entry fields 620-621 can be displayed on the display at the same time. When the display of the client device displays the GUI 702, the widgets 614-615 and data entry field 622 can be displayed on the display at the same time. In exemplary embodiments, the abstraction engine 130 can programmatically determine which widgets and data entry fields to place in which GUIs based on a flow of the software application and can insert a widget 710 (e.g., a next button) to facilitate transition from the GUI 700 to the GUI 701 and from the GUI 701 to the GUI 702.

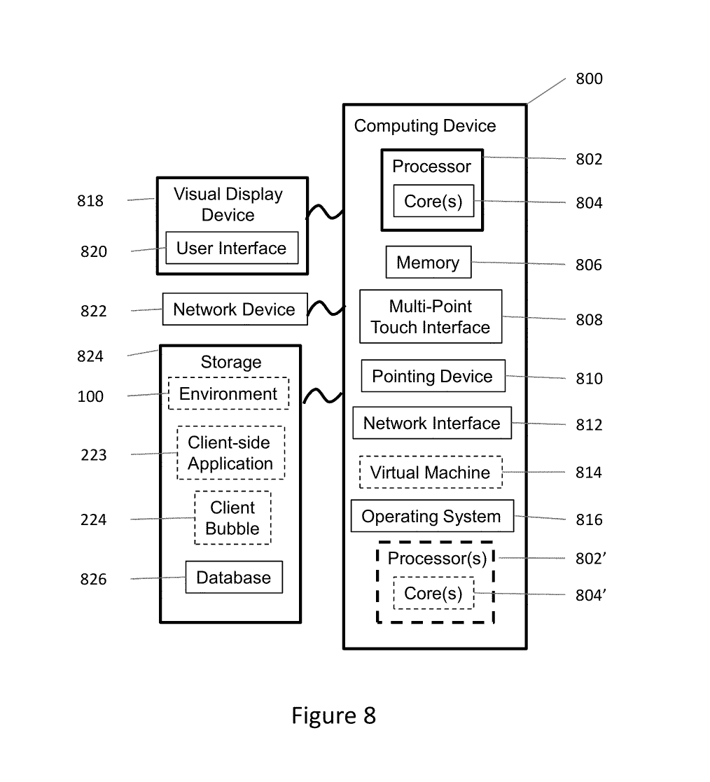

FIG. 8 is a block diagram of an exemplary computing device 800 that may be used in to implement exemplary embodiments of the environment 100 or portions thereof. For example, the environment 100 (e.g., one or more of the engines 110, 120, 130, and 140) or client-side application 223 can be implemented in accordance with one or more instances of the exemplary computing device 800. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 806 included in the computing device 800 may store computer-readable and computer-executable instructions or software for implementing exemplary embodiments of the environment 100 (or components thereof) for instances of the computing device 800 that are implemented as servers or the client-side application for instances of the computing device 800 that are implemented as a client device.

The computing device 800 also includes configurable and/or programmable processor 802 and associated core 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling system hardware. Processor 802 and processor(s) 802′ may each be a single core processor or multiple core (804 and 804′) processor.

Virtualization may be employed in the computing device 800 so that infrastructure and resources in the computing device may be shared dynamically. A virtual machine 814 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof.

A user may interact with the computing device 800 through a visual display device 818, such as a computer monitor, which may display one or more user interfaces 820 that may be provided in accordance with exemplary embodiments. The computing device 800 may include other I/O devices for receiving input from a user, for example, a keyboard or any suitable multi-point touch interface 808, a pointing device 810 (e.g., a mouse). The keyboard 808 and the pointing device 810 may be coupled to the visual display device 818. The computing device 800 may include other suitable conventional I/O peripherals.

The computing device 800 may also include one or more storage devices 824, such as a hard-drive, CD-ROM, or other computer readable media, for storing data and computer-readable instructions and/or software that implement exemplary embodiments of the environment 100 described herein. Exemplary storage device 824 may also store on or more client bubbles (e.g., client bubble 224), as well as one or more databases, which can store any suitable information required to implement exemplary embodiments. For example, exemplary storage device 824 can store one or more databases 826 for storing information, such as client parameters, application parameters, the software applications themselves, client bubbles, and/or any other information to be used by embodiments of the environment 100. The databases may be updated by manually or automatically at any suitable time to add, delete, and/or update one or more items in the databases.

The computing device 800 can include a network interface 812 configured to interface via one or more network devices 822 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 812 may include a built-in network adapter, network interface card, PCMCIA network card, card bus network adapter, wireless network adapter, USB network adapter, modem or any other device suitable for interfacing the computing device 800 to any type of network capable of communication and performing the operations described herein. Moreover, the computing device 800 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 800 may run any operating system 816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 816 may be run in native mode or emulated mode. In an exemplary embodiment, the operating system 816 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A method of transforming an incompatible software application to a compatible software application for a client device in a client-server environment comprising:
receiving a request from a client device for an incompatible software application stored by a server, the request being associated with at least one client parameter associated with the client device identifying an operational characteristic of the client device;
programmatically identifying an application parameter associated with the incompatible software application; and
programmatically modifying a graphical user interface of the incompatible application for display on the client device based on the client parameter and the application parameter.

2. The method of claim 1, further comprising applying at least one rule to the software application to determine a manner in which the software application operates for the client device based on the client parameter and the application parameter.

3. The method of claim 2, wherein the at least one rule is a presentation rule and applying the at least one rule comprises controlling an appearance of the software application on the display of the client device.

4. The method of claim 3, wherein controlling an appearance of the software application comprises programmatically creating a series of client device specific graphical user interfaces to replace the graphical user interface of the software application.

5. The method of claim 2, wherein the at least one rule is an interaction rule and applying the at least one rule comprises controlling a manner in which the client device and the software application interact.

6. The method of claim 1, further comprising programmatically configuring an execution interface to provide a compatible execution environment between the client device and the incompatible software application based on the client parameter and the application parameter.

7. The method of claim 6, wherein configuring an interface comprises establishing an application abstraction layer to provide the execution interface to control an interaction between the client device and the software application.

8. The method of claim 1, further comprising:
abstracting the software application to form an abstracted version of the software application in which an implementation detail of the software application is hidden from the client device; and
executing the abstracted version of the software application by the client device.

9. The method of claim 8, wherein at least one of the client parameter or the application parameter is contained in a client bubble maintained by the client device.

10. The method of claim 9, wherein the client bubble defines a state of the execution of the abstracted version of the software application by the client device.

11. The method of claim 10, further comprising storing a copy of the client bubble in a server.

12. The method of claim 11, further comprising transmitting the copy of the client bubble from the server to the client device to restore the of execution of the abstracted version of the software application for the client device in response to ceasing execution of the abstracted version of the software application by the client device.

13. The method of claim 11, further comprising transmitting the copy of the client bubble from the server to a different client device in response to a request from the client device to transfer an execution of the abstract version of the software application to the different device.

14. A non-transitory computer readable medium storing instructions, wherein execution of the instructions by a processing device causes the processing device to implement a process comprising:
receiving a request from a client device for an incompatible software application stored by a server, the request being associated with at least one client parameter associated with the client device identifying an operational characteristic of the client device;
programmatically identifying an application parameter associated with the incompatible software application; and
programmatically modifying a graphical user interface of the incompatible application for display on the client device based on the client parameter and the application parameter.

15. The medium of claim 14, wherein execution of the instructions by a processing device causes the processing device to apply at least one rule to the software application to determine a manner in which the software application operates for the client device based on the client parameter and the application parameter.

16. The medium of claim 15, wherein the at least one rule is a presentation rule and applying the at least one rule comprises controlling an appearance of the software application on a display of the client device.

17. The medium of claim 15, wherein the at least one rule is an interaction rule and applying the at least one rule comprises controlling a manner in which the client device and the software application interact.

18. The medium of claim 15, wherein execution of the instructions by a processing device causes the processing device to programmatically configuring an execution interface to provide a compatible execution environment between the client device and the incompatible software application based on the client parameter and the application parameter.

19. The medium of claim 18, wherein at least one of the client parameter or the application parameter is contained in a client bubble maintained by the client device, the client bubble defining a state of the execution of the abstracted version of the software application by the client device.

20. The medium of claim 19, wherein a copy of the client bubble is stored by a server and execution of the instructions by the processing device cause the processing device to transmit the copy of the client bubble from the server to the client device to restore the of execution of the abstracted version of the software application for the client device in response to ceasing execution of the abstracted version of the software application by the client device.

21. The medium of claim 19, wherein a copy of the client bubble is stored by a server and execution of the instructions by the processing device cause the processing device to transmit the copy of the client bubble from the server to a different client device in response to a request from the client device to transfer an execution of the abstract version of the software application to the different device.

22. A system for transforming an incompatible software application to a compatible software application in a client-server environment, the system comprising:
one or more servers programmed to
receive a request from a client device over a communications network for an incompatible software application stored by the one or more servers, the request being associated with at least one client parameter associated with the client device identifying an operational characteristic of the client device;
identify an application parameter associated with the incompatible software application; and
modify a graphical user interface of the incompatible application for display on the client device based on the client parameter and the application parameter.

23. The system of claim 22, wherein the one or more servers are programmed to:
apply a presentation rule to the software application to control an appearance of the graphical user interface on a display of the client device;
apply an interaction rule to the software application to control a manner in which the client device and the software application interact; and
configure an execution interface to provide a compatible execution environment between the client device and the software application based on the client parameter and the application parameter.

24. The system of claim 23, further comprising a client device programmed to request execution of the software application and maintain a client bubble, the client bubble describing the client parameter associated with the client device and a state of execution of the application by the client device.

25. The system of claim 22, wherein the one or more servers are programmed to:
store a copy of the client bubble corresponding to a client device, the client bubble including information corresponding to a state of execution of the software application by the client device; and
transmit the copy of the client bubble from the server to the client device to restore the of execution of the software application for the client device in response to ceasing execution of the software application by the client device or transmit the copy of the client bubble from the server to a different client device in response to a request from the client device to transfer an execution of the software application to the different device.

26. The system of claim 22, wherein of the one or more servers are programmed to control access to at least one of business logic or business data by the client device executing the software application.
